(19) United States
(12) Patent Application Publication
(10) Pub. No.: US 2018/0225785 A1
(43) Pub. Date: Aug. 9, 2018

(54) SYSTEMS AND METHODS FOR MANAGING PROPERTY DATA

(71) Applicant: Stessa, Inc., Emeryville, CA (US)

(72) Inventors: Jonah Schwartz, San Francisco, CA (US); Heath Andrew Silverman, San Francisco, CA (US)

(21) Appl. No.: 15/426,961

(22) Filed: Feb. 7, 2017

(51) Int. Cl. G06Q 50/16; G06Q 40/02; G06Q 30/06; G06Q 40/06

(52) U.S. Cl. CPC G06Q 50/163; G06Q 40/06; G06Q 30/0645; G06Q 40/02

(57) ABSTRACT

Systems and methods for managing property information. A list of accounts is accessed from a service provider system. User selection of an account is selected from the list of accounts. Tenant rent data is received for a property address. Property information is stored with user account information for an account of the platform system, an identifier of the service provider account, access information for the service provider system, and the tenant rent data. The property information includes the property address. Additional information for the property address is monitored. A notification for the property address is generated based on the accessed additional information. The additional information includes transaction information for the service provider account accessed from the service provider system, property data for the property address accessed from a property database system, and listing information accessed from a listing database for a location of the property address.

### TECHNICAL FIELD

This disclosure herein relates generally to data management systems, and more specifically to new and useful systems and methods for managing property data.

### BACKGROUND

Property data is typically provided by a plurality of separate computing systems. The disclosure herein provides such new and useful systems and methods for managing property data provided by a plurality of separate computing systems.

### BRIEF DESCRIPTION OF THE FIGURES

FIG. 1 is a schematic representation of a system in accordance with embodiments;

FIGS. 2A-C are a flowchart representations of methods in accordance with embodiments; and

FIG. 3 is an architecture diagram of a system, in accordance with embodiments.

### DESCRIPTION OF EMBODIMENTS

The following description of embodiments is not intended to limit the invention to these embodiments, but rather to enable any person skilled in the art to make and use the embodiments.

### Overview

Some embodiments herein include systems and methods that enable property owners and asset managers to manage residential and commercial real estate investments. After registering a property and connecting financial data, an owner gets a comprehensive and consolidated view of their portfolio (property group) with all the relevant metrics such as rent roll, operating expenses, and loan-to-value in an easy-to-understand format. Some embodiments herein include dashboards, alerts, and actionable insights for helping both novice and sophisticated investors drive operational efficiencies, maximize revenue, and improve overall portfolio performance.

Optimizing a real estate portfolio can involve tedious manual effort, which might cause some investors to see sub-optimal returns. Some embodiments herein utilize intelligence to identify pressing, often overlooked issues such as a water leak, below-market rent, or property tax inconsistency, and automate manual tasks such as preparing a P&L, rent-roll, and schedule of real-estate owned appropriate for a loan application.

### Systems

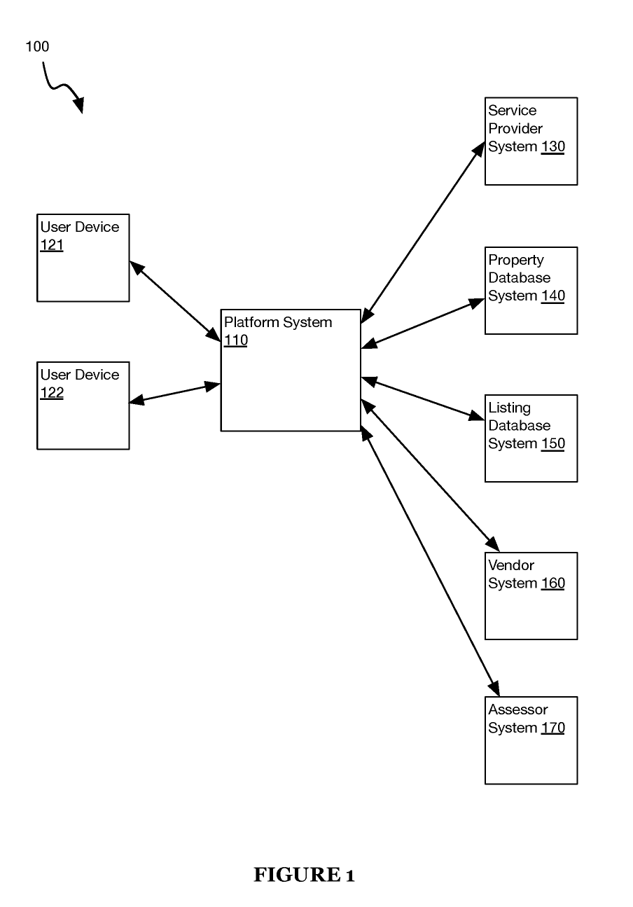

FIG. 1 is a schematic representation of a system 100 in accordance with embodiments. In some embodiments, the system 100 includes a property management platform system 110, a first user device (e.g., 121, 122), a first service provider system 130, a first property database system 140, and a first listing database system 150.

In some embodiments, the system 100 includes a vendor system 160.

In some embodiments, the first user device (e.g., 121, 122) is one of a computer, tablet, smartphone, phone, server, smart watch, or any other suitable type of computing device.

In some embodiments, the first service provider system 130 is a banking system. In some embodiments, the first service provider system 130 manages at least one of a checking account, a savings account, a credit account, and a mortgage account. In some embodiments, the first service provider system 130 is a system of a utility provider (e.g., a gas, water, power, telecommunication provider, and the like).

In some embodiments, the vendor system 160 is a system of a third-party vendor, such as, for example, a property manager vendor system, a security vender system, a gardener vendor system, a janitorial services system, and the like.

In some embodiments, the first property database system 140 is a system that manages and provides property data (e.g., Zillow.com). In some embodiments, the first property database system 140 is third-party database of public records.

In some embodiments, property data includes at least one of property address, number of bedrooms, number of bathrooms, number of units, property value, property size (e.g., square footage), year built, date of last sale, price of last sale.

In some embodiments, the first listing database system 150 is a system that manages rental listings. In some embodiments, each rental listing includes rent price, property location, and property information (e.g., number of bedrooms, number of bathrooms, amenities, and the like).

In some embodiments, the property management platform system 110 is communicatively coupled to each of the first user device (e.g., 121, 122), the first service provider system 130, the first property database system 140, and the first listing database system 150 via a network (e.g., the Internet). In some embodiments, the property management platform system 110 is communicatively coupled to each of the first user device (e.g., 121, 122), the first service provider system 130, the first property database system 140, the vendor system 160, and the first listing database system 150 via a network (e.g., the Internet).

In some embodiments, the system 100 includes a property assessor system 170 that is communicatively coupled to the platform system 110. In some embodiments, the assessor system 170 is a system of a county assessor, and the system 170 is constructed to provide property tax information for a specified property, and property assessment information for a specified property. In some embodiments, the assessor system 170 is a third-party database of assessor records, and the system 170 is constructed to provide property tax information for a specified property, and property assessment information for a specified property.

### Methods

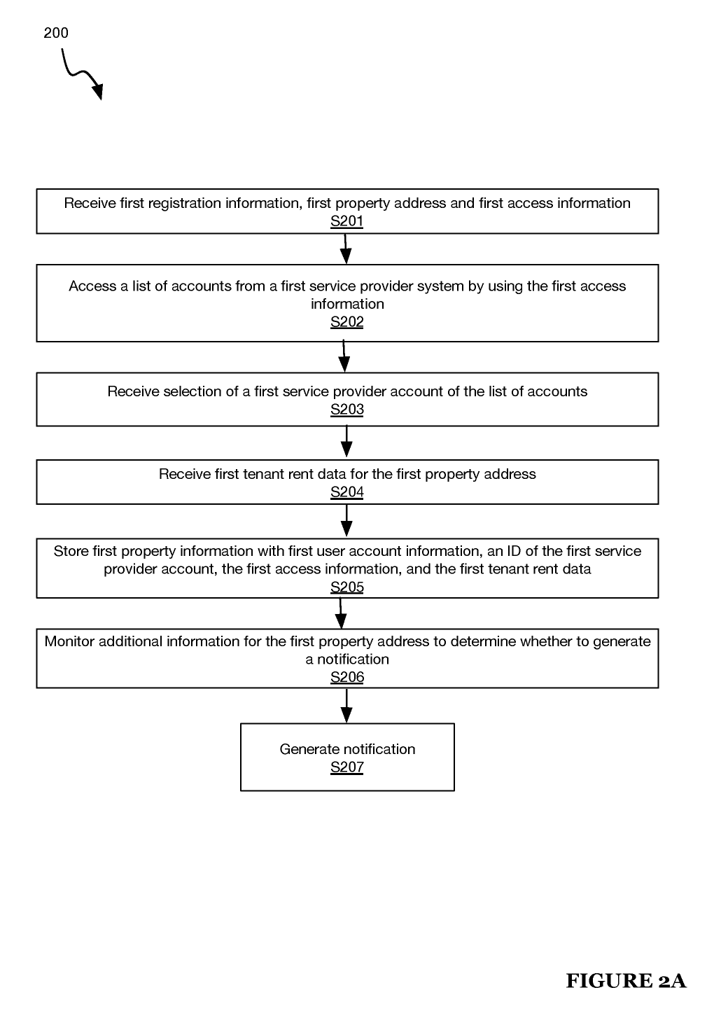

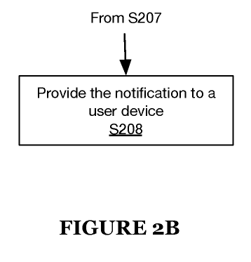

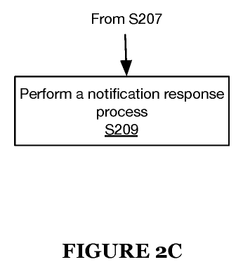

FIG. 2A is a flowchart representation of a method 200 in accordance with embodiments. In some embodiments, the method 200 is performed by the platform system 110. In some embodiments, the method 200 includes: receiving, from an external first user device (e.g., 121, 122), first user account information (e.g., an e-mail address, user ID, security token, username/pass, OATH token) for an account of the platform system, a first property address, and first access information (e.g., username/pass, security token, OATH token, and the like) for an external first service provider system (e.g., 130) (process S201); accessing a list of accounts (e.g., checking accounts, mortgage accounts, savings accounts, credit accounts) from the first service provider system by using the first access information (process S202); receiving, from the first user device, first service provider account user selection of a first service provider account (e.g. a checking account, a savings account) of the list of accounts (process S203); receiving first tenant rent data for the first property address (process S204); storing first property information in association with the first user account information, an identifier of the first service provider account (e.g., an account ID for the selected account), the first access information, and the first tenant rent data, wherein the first property information includes the first property address (process S205); monitoring additional information for the first property address to determine whether to generate a notification for the first property address (process S206); responsive to a determination to generate the notification, generating the notification (process S207). In some embodiments, monitoring additional information (the process S206) includes: accessing first transaction information (e.g., a list of credit and debit transactions) for the first service provider account from the first service provider system by using the first access information. In some embodiments, monitoring additional information (the process S206) includes: accessing first property data (e.g., number of bedrooms, number of bathrooms, property size, property valuation) for the first property address from an external property database system (e.g., 140). In some embodiments, monitoring additional information (the process S206) includes: accessing listing information (e.g., rents) from a listing database system (e.g., 150) for a location of the first property address.

In some embodiments, the additional information includes the first transaction information, the first property data, and the listing information.

In some embodiments, the method 200 further includes: providing the notification to at least one of the first user device (e.g., 121) and a second user device (e.g., 122) (process S208 of FIG. 2B). In some embodiments, the method 200 further includes: providing the notification the first user device (e.g., 121) (process S208 of FIG. 2B). In some embodiments, the method 200 further includes: providing the notification a second user device (e.g., 122) (process S208 of FIG. 2B). In some embodiments, the method 200 further includes: performing a notification response process responsive to generation of the notification (process S209 of FIG. 2C).

In some embodiments, monitoring additional information includes: the platform system 110 periodically accessing the additional information. In some embodiments, monitoring additional information includes: the platform system 110 accessing the additional information responsive to a trigger event. In some embodiments, a trigger event includes reception of a user request provided by a user device (e.g., 121, 122). In some embodiments, a trigger event includes reception of a notification provided by an external system (e.g., the property database system 140, the listing database system 150, the vendor system 160, and the assessor system 170).

In some embodiments, monitoring additional information (the process S206) includes: accessing assessor information (e.g., assessed value, property tax information) from an assessor database system (e.g., 170) for a location of the first property address. In some embodiments, monitoring includes: determining whether to generate a notification for the first property address based on the accessed assessor information.

In some embodiments, monitoring additional information (the process S206) includes: accessing vendor information (e.g., property manager information, gardener vendor information, security vendor information, janitorial services vendor information, and the like) from a vendor system (e.g., 160). In some embodiments, monitoring includes: determining whether to generate a notification for the first property address based on the accessed vendor information.

In some embodiments, the first service provider account is a savings account. In some embodiments, the first service provider account is a checking account. In some embodiments, the first service provider account is a credit card account.

In some embodiments, the method 200 includes: the platform system receiving (from the first user device) first loan account information for the first property address. In some embodiments, the first loan account information includes access information for a first loan service provider system. In some embodiments, the first service provider system is the first loan service provider system. In some embodiments, the first access information is access information for the first loan service provider system. In some embodiments, the first loan account information includes an account identifier for a loan account of the first loan service provider system. In some embodiments, the first loan account information specifies user selection of a loan service provider system. In some embodiments, the first loan account information specifies user selection of an account identifier for a loan account of the first loan service provider system.

In some embodiments, receiving first tenant rent data for the first property address (process S204) includes: the platform system receiving the first tenant rent data from the first user device (e.g., 121). In some embodiments, receiving first tenant rent data for the first property address (process S204) includes: the platform system receiving the first tenant rent data from a second user device (e.g., 122). In some embodiments, receiving first tenant rent data for the first property address (process S204) includes: the platform system receiving the first tenant rent data from an external vendor system (e.g., a property manager vendor system).

### API

In some embodiments, a method includes the platform system receiving first user account information (e.g., an e-mail address, user ID, security token, username/pass, OATH token) for an account of the platform system, a first property address, and first access information (e.g., username/pass, security token, OATH token, and the like) for an external first service provider system (e.g., 130) from an external user system via an API (Application Program Interface) of the platform system; accessing a list of accounts (e.g., checking accounts, mortgage accounts, savings accounts, credit accounts) from the first service provider system by using the first access information; receiving, from the user system via the API, first service provider account user selection of a first service provider account (e.g. a checking account, a savings account) of the list of accounts; receiving first tenant rent data for the first property address; storing first property information in association with the first user account information, an identifier of the first service provider account (e.g., an account ID for the selected account), the first access information, and the first tenant rent data, wherein the first property information includes the first property address; monitoring additional information for the first property address to determine whether to generate a notification for the first property address; responsive to a determination to generate the notification, generating the notification. In some embodiments, the external user system is a property manager system. In some embodiments, the external user system is an asset manager system. In some embodiments, the API is a REST API.

In some embodiments, the user system is communicatively coupled to a user device (e.g., 121, 122), and the user system provides the first user account information, the first property address, and the first access information to the platform system responsive to a provisioning request received by the user system from the user device.

In some embodiments, the user system is communicatively coupled to a user device (e.g., 121, 122), and the user system provides the first user account information, the first property address, the first access information, and the first service provider account user selection to the platform system responsive to a provisioning request received by the user system from the user device.

In some embodiments, the provisioning request is a one-click provisioning request.

### Notification: Suggest New Vendor

In some embodiments, the notification is a notification to suggest a new vendor, and monitoring (process S206) includes: determining to generate a new vendor the notification.

In some embodiments, the platform system 110 determines whether to generate the new vendor notification based on the first transaction information. In some embodiments, the first transaction information indicates a charge for vendor services provided by a current vendor, the platform system accesses vendor information for at least one new vendor from an external system, and the platform system determines to generate the new vendor notification based at least on a comparison of the charge for the current vendor and pricing information for at least one new vendor of the accessed vendor information.

In some embodiments, monitoring (process S206) includes: accessing current vendor information for a current vendor of the first property address. In some embodiments, the platform system 110 determines whether to generate the new vendor notification based on current vendor information for a current vendor. In some embodiments, the platform system 110 accesses the current vendor information from an external system. In some embodiments, the external system is a vendor system. In some embodiments, the external system is a user device. In some embodiments, the external system is a tenant device. In some embodiments, the external system includes a database of vendor reviews. In some embodiments, the external system includes a database of vendor ratings. In some embodiments, the current vendor information is stored at the platform system 110. In some embodiments, the current vendor information is generated by the platform system 110. In some embodiments, the current vendor information is provided to the platform system by a system of the current vendor. In some embodiments, the current vendor information is provided to the platform system by a user device. In some embodiments, the current vendor information is provided to the platform system by a tenant device. In some embodiments, the current vendor information includes a vendor rating. In some embodiments, the current vendor information includes a vendor review. In some embodiments, the current vendor information includes vendor pricing information.

In some embodiments, the platform system 110 determines to generate the new vendor notification based on current vendor information for the current vendor that indicates a vendor rating below a predetermined threshold value.

In some embodiments, the platform system 110 determines a current vendor rating for the current vendor based on the current vendor information.

In some embodiments, the platform system 110 determines to generate the new vendor notification in a case where the determined current vendor rating is below a predetermined threshold value.

In some embodiments, the platform system 110 determines to generate the new vendor notification based on current vendor information for the current vendor that indicates vendor pricing that exceeds a predetermined threshold value.

In some embodiments, monitoring (process S206) includes: accessing new vendor information for a new vendor. In some embodiments, the platform system 110 accesses the new vendor information for at least one new vendor from an external system. In some embodiments, the external system is a vendor system. In some embodiments, the external system is a user device. In some embodiments, the external system is a tenant device. In some embodiments, the external system includes a database of vendor reviews. In some embodiments, the external system includes a database of vendor ratings. In some embodiments, the new vendor information is stored at the platform system 110. In some embodiments, the new vendor information is generated by the platform system 110. In some embodiments, the new vendor information is provided to the platform system by a system of at least one new vendor. In some embodiments, the new vendor information is provided to the platform system by a user device. In some embodiments, the new vendor information is provided to the platform system by a tenant device. In some embodiments, the new vendor information includes a vendor rating. In some embodiments, the new vendor information includes a vendor review. In some embodiments, the new vendor information includes vendor pricing information.

In some embodiments, the platform system 110 determines to generate the new vendor notification based on new vendor information for the new vendor that indicates a vendor rating above a vendor rating of the current vendor. In some embodiments, the platform system 110 determines a new vendor rating for at least one new vendor based on the new vendor information, and determines to generate the new vendor notification in a case where the determined new vendor rating is higher than a vendor rating of the current vendor.

In some embodiments, the platform system 110 determines a vendor pricing of the current vendor. In some embodiments, the platform system 110 determines a vendor pricing of the current vendor based on the first transaction information. In some embodiments, the platform system 110 determines a new vendor pricing for at least one new vendor based on the new vendor information, and determines to generate the new vendor notification in a case where the determined new vendor pricing is lower than a vendor pricing of the current vendor.

In some embodiments, monitoring (process S206) includes: accessing information provided by a new vendor system. In some embodiments, the platform system 110 determines whether to generate the new vendor notification based on information provided by a new vendor system. In some embodiments, the information provided by the new vendor system is a vendor proposal to provide services. In some embodiments, responsive to the information provided by the new vendor system, the platform system 110 determines to generate the new vendor notification. In some embodiments, responsive to the information provided by the new vendor system, the platform system 110 determines a match between the first property information and the new vendor information, and responsive to a match, the platform system 110 determines to generate the new vendor notification. In some embodiments, responsive to the information provided by the new vendor system, the platform system 110 determines whether the new vendor system is permitted to provide new vendor notifications, and responsive to a determination that the new vendor system is permitted to provide new vendor notifications, the platform system 110 determines to generate the new vendor notification. In some embodiments, the new vendor system is permitted to provide new vendor notifications in a case where an entity of the new vendor system has paid a fee to an entity of the platform system 110.

In some embodiments, monitoring includes: determining a charge for vendor services provided for the first property address by a current vendor based on the first transaction information; accessing vendor information for at least one new vendor from an external system (e.g., a vendor system, a vendor rating system, a business directory system, a second service provider system, and the like); determining to generate the new vendor notification in a case where a charge for the current vendor is greater than pricing information for at least one new vendor of the accessed vendor information, wherein generating the notification includes: generating a new vendor notification. In some embodiments, monitoring includes: determining a rating for a current vendor that provides a service for the first property address; determining a rating for at least one new vendor by using an external system (e.g., a vendor system, a vendor rating system, a business directory system, a second service provider system, and the like); determining to generate the new vendor notification in a case where a rating for the current vendor is lower than the determined rating for the at least one new vendor, wherein generating the notification includes: generating a new vendor notification.

### Notification: Suggest New Loan

In some embodiments, the notification is a notification to suggest a new loan, and monitoring (process S206) includes: determining to generate a new loan notification.

In some embodiments, monitoring (process S206) includes: accessing current loan information of a current loan for the first property address.

In some embodiments, the current loan information is provided by the first service provider system. In some embodiments, the platform system uses the first access information to access the current loan information from the first service provider system.

In some embodiments, the current loan information is provided by an external loan service provider system. In some embodiments, the platform system receives first loan account information for the first property address, and uses the first loan account information to access the current loan information from the loan service provider system.

In some embodiments, the platform system receives the first loan account information from the first user device.

In some embodiments, the first loan account information includes access information for the loan service provider system. In some embodiments, the loan account information includes an account identifier for a loan account of the first loan service provider system. In some embodiments, the loan account information specifies user selection of a loan service provider system. In some embodiments, the loan account information specifies user selection of an account identifier for a loan account of the first loan service provider system.

In some embodiments, the platform system 110 determines whether to generate the new loan notification based on the current loan information. In some embodiments, the platform system determines to generate the new loan notification based on a comparison between a current interest rate indicated by the current loan information and a loan interest rate threshold value. In some embodiments, the platform system determines to generate the new loan notification in a case where the current interest rate indicated by the current loan information exceeds the loan interest rate threshold value. In some embodiments, the platform system adjusts the loan interest rate threshold value. In some embodiments, the platform system adjusts the loan interest rate threshold value based on user input received by the first user device. In some embodiments, the platform system adjusts the loan interest rate threshold value based on interest rate information. In some embodiments, the platform system adjusts the loan interest rate threshold value based on interest rate information provided by an external system (e.g., Bankrate.com, Bloomberg.com, a financial news reporting system, and the like). In some embodiments, the platform system adjusts the loan interest rate threshold value based a change in interest rate reported by an external system (e.g., Bankrate.com, Bloomberg.com, a financial news reporting system, and the like).

In some embodiments, the platform system determines to generate the new loan notification based on an expiration date of a fixed rate term of a variable loan as indicated by the current loan information. For example, if the fixed rate term of a variable loan is about to expire (at which point the interest rate becomes a variable interest rate), the platform system determines to generate the new loan notification.

In some embodiments, the platform system access new loan information, and the platform system 110 determines whether to generate the new loan notification based on the current loan information and the accessed new loan information.

In some embodiments, current loan information specifies a current interest rate for the first property address, the platform system accesses new loan information, and the platform system determines to generate the new loan notification based at least on a comparison of the current interest rate and at least one interest rate specified by the new loan information. In some embodiments, the platform system determines to generate the new loan notification in a case where the current interest rate indicated by the current loan information exceeds at least one interest rate specified by the new loan information. In some embodiments, the platform system accesses the new loan information from a plurality of external loan service provider systems, and the new loan information includes information provided by the plurality of external loan service provider systems. In some embodiments, the new loan information includes information provided by the first service provider system. In some embodiments, the platform system accesses the new loan information from the first service provider system, and the new loan information includes information provided by the first service provider system.

In some embodiments, the method 200 comprises: the platform system identifying a second property address, wherein an owner of a property identified by the second property address is an owner of the property of the first property address. In some embodiments, identifying a second property address includes: determining whether the second property address is stored by the platform system in association with the first user account information.

In some embodiments, accessing new loan information includes accessing portfolio loan information in a case where the platform system identifies the second property address. In some embodiments, accessing new loan information includes accessing portfolio loan information in a case where the second property address is stored by the platform system in association with the first user account information. In some embodiments, the accessed portfolio loan information includes interest rate information for a loan for both the first property address and the second property address.

In some embodiments, the platform system determines to generate the new loan notification based at least on a comparison of the current interest rate of the first property address and at least one interest rate specified by the portfolio loan information. In some embodiments, the platform system determines to generate the new loan notification in a case where the current interest rate indicated by the current loan information exceeds at least one interest rate specified by the portfolio loan information.

In some embodiments, monitoring includes: accessing current loan information of a current loan for the first property address; determining to generate the notification in a case where a current interest rate indicated by the current loan information exceeds a loan interest rate threshold value, wherein generating the notification includes: generating a new loan notification. In some embodiments, monitoring includes: accessing current loan information of a current loan for the first property address; determining to generate the notification based on an expiration date of a fixed rate term of a variable loan as indicated by the current loan information, wherein generating the notification includes: generating a new loan notification. In some embodiments, monitoring includes: accessing current loan information of a current loan for the first property address; accessing new loan information provided by a plurality of external loan service provider systems; determining to generate the notification in a case where a current interest rate indicated by the current loan information exceeds at least one interest rate specified by the new loan information, wherein generating the notification includes: generating a new loan notification. In some embodiments, monitoring includes: accessing current loan information of a current loan for the first property address; determining whether a second property address is stored by the platform system in association with the first user account information; in a case where the second property address is stored by the platform system in association with the first user account information, accessing new portfolio loan information provided by a plurality of external loan service provider systems; determining to generate the notification in a case where the current interest rate indicated by the current loan information exceeds at least one interest rate specified by the new portfolio loan information, wherein the accessed portfolio loan information includes interest rate information for a loan for both the first property address and the second property address, and wherein generating the notification includes: generating a new portfolio loan notification.

### Notification: Tenant Notification

In some embodiments, the notification is a tenant notification, and monitoring (process S206) includes: determining to generate a tenant notification.

In some embodiments, the platform system receives first tenant notification for a first tenant of the first property address, the platform system accesses credit information for the first tenant from an external credit bureau system by using the first tenant information, and the platform system 110 determines whether to generate the tenant notification based on the credit information for the first tenant.

In some embodiments, the tenant credit notification indicates a likelihood that the first tenant identified by the first tenant information will default on rent. In some embodiments, the tenant credit notification indicates whether the first property address matches a current address of the first tenant as indicated by the accessed credit information.

In some embodiments, monitoring includes: determining a current residence location for a tenant of the first property address by using an external social media system; determining to generate a tenant notification in a case where the current residence location is different from a location of the first property address, wherein generating the notification includes: generating a tenant notification. In some embodiments, monitoring includes: determining a current residence location for a tenant of the first property address by using an external credit bureau system; determining to generate a tenant notification in a case where the current residence location is different from a location of the first property address, wherein generating the notification includes: generating a tenant notification.

### Notification: Public Service

In some embodiments, the notification is a public service notification, and monitoring (process S206) includes: determining to generate a public service notification.

In some embodiments, monitoring (process S206) includes accessing public service information from an external public service system (e.g., a local government system, a state government system, a federal government system) for a location (e.g., country, state, city, neighborhood, community, zip code, and the like) of the first property address, and the platform system 110 determines whether to generate the public service notification based on the accessed public service information. In some embodiments, the public service notification indicates availability of a free service provided by a public entity (e.g., federal entity, state entity, city entity) for the first property address. In some embodiments, the public service notification indicates availability of a free product provided by a public entity (e.g., federal entity, state entity, city entity) for the first property address.

### Notification: Crowdsourced

In some embodiments, the notification is a crowdsourced suggestion notification, and monitoring (process S206) includes: determining to generate a crowdsourced suggestion notification.

In some embodiments, monitoring (process S206) includes accessing crowdsourced suggestions from a crowdsourcing suggestion system. In some embodiments, the crowdsourcing suggestion system is included in the platform system 110. In some embodiments, the crowdsourcing suggestion system is external to the platform system 110. In some embodiments, the platform system provides at least a subset of information stored for the first property address to the crowdsourcing suggestion system, and the crowdsourcing suggestion system receives crowdsourced suggestions for the first property address from client systems external to the platform system and the crowdsourcing suggestion system, and the crowdsourcing suggestion system provides received crowdsourced suggestions for the first property address to the platform system 110; the platform system 110 determines whether to generate the crowdsourced suggestion notification based on the received crowdsourced suggestions. In some embodiments, the platform system generates a crowdsourced suggestion notification in a case where the platform system receives at least one crowdsourced suggestion. In some embodiments, the crowdsourced suggestion notification includes at least one crowdsourced suggestion received by the platform system from the crowdsourcing suggestion system.

### Notification: Tenant Notification by Using Social Media

In some embodiments, the notification is a social media tenant notification, and monitoring (process S206) includes: determining to generate a social media tenant notification.

In some embodiments, the platform system receives first tenant notification for a first tenant of the first property address, the platform system accesses social information for the first tenant from an external social media system by using the first tenant information, and the platform system 110 determines whether to generate the social media tenant notification based on the social media information for the first tenant. In some embodiments, determining whether to generate the social media tenant notification based on the social media information for the first tenant includes: the platform system determining a current location of residence for the first tenant by using the social media information, and determining to generate the social media tenant notification in a case where the platform system determines that the current location of residence is different from a location of the first property address.

### Notification: Lease Violation

In some embodiments, the notification is a lease violation notification, and monitoring (process S206) includes: determining to generate a lease violation notification.

In some embodiments, monitoring (process S206) includes accessing vacation rental listing information from an external vacation rental system (e.g., Airbnb.com), and the platform system 110 determines to generate the lease violation notification in a case where the first property address is identified by the accessed vacation rental listing information.

In some embodiments, monitoring includes: accessing vacation rental listing information from an external vacation rental system; determining to generate a lease violation notification in a case where the first property address is identified by the accessed vacation rental listing information, wherein generating the notification includes: generating a lease violation notification.

### Notification: Utility Notification

In some embodiments, the notification is a utility notification, and monitoring (process S206) includes: determining to generate a utility notification. In some embodiments, the platform system 110 determines to generate the utility notification based on the first transaction information.

In some embodiments, the platform system 110 determines to generate the utility notification responsive to identification of a transaction of the first transaction information that indicates an increase in a utility cost above a threshold value. In some embodiments, the platform system 110 identifies a current utility cost for a first utility by using the first transaction information; the platform system 110 identifies a previous utility cost for the first utility by using the first transaction information, and determines to generate the utility notification responsive to a determination that a difference between the current utility cost and the previous utility cost corresponds to an increase in a utility cost for the first utility above a threshold value for the first utility.

In some embodiments, the platform system 110 determines to generate the utility notification responsive to identification of a transaction of the first transaction information that indicates an increase in a water utility cost above a threshold value. In some embodiments, the utility notification indicates a possible water leak.

In some embodiments, monitoring includes: identifying a current utility cost for a first utility by using the first transaction information; identifying a previous utility cost for the first utility by using the first transaction information, determining to generate a utility notification responsive to a determination that a difference between the current utility cost and the previous utility cost corresponds to an increase in a utility cost for the first utility above a threshold value for the first utility, wherein generating the notification includes: generating a utility notification.

### Notification: Property Tax Notification

In some embodiments, the notification is a property tax notification, and monitoring (process S206) includes: determining to generate a property tax notification.

In some embodiments, monitoring (process S206) includes: accessing assessor information (e.g., assessed value, property tax information) from an assessor database system (e.g., 170) for a location of the first property address. In some embodiments, determining whether to generate a notification comprises: determining whether to generate a notification for the first property address based on the accessed assessor information.

In some embodiments, the platform system 110 determines to generate the property tax notification responsive to a determination that an assessed value for the first property address (as determined by the accessed assessor information) exceeds a property value for the first property address (as indicated by the accessed first property data) by a threshold value.

In some embodiments, the platform system 110 determines to generate the property tax notification responsive to a determination that an assessed value for the first property address (as determined by the accessed assessor information) exceeds a property value for the first property address (as determined by tenant rent data for the first property address) by a threshold value.

In some embodiments, monitoring includes: determining an assessed value for the first property address by accessing an assessor database system; determining a current property value for the first property address; determining to generate a property tax notification responsive to a determination that the assessed value for the first property address is greater than the current property value for the first property address by a threshold value, wherein generating the notification includes: generating a property tax notification. In some embodiments, the platform system determines the current property value based on tenant rent information stored in association with the first property address. In some embodiments, the platform system determines the current property value based on information accessed from an external property database system.

### Notification: Market Rent Notification

In some embodiments, the notification is a market rent notification, and monitoring (process S206) includes: determining to generate a market rent notification.

In some embodiments, monitoring (process S206) includes: accessing listing information (e.g., rents) from a listing database system (e.g., 150) for a location of the first property address.

In some embodiments, the platform system 110 determines to generate the market rent notification based on the accessed listing information.

In some embodiments, determining to generate the market rent notification based on the accessed listing information includes: determining a market rent for the first property based on the accessed listing information, and determining to generate the notification responsive to a determination that the market rent exceeds the first tenant rent data by a threshold value.

In some embodiments, monitoring (process S206) includes: determining a market rent for the first property, and determining to generate the notification responsive to a determination that the market rent exceeds the first tenant rent data by a threshold value, wherein determining the market rent includes determining the market rent based rent data stored by the property management platform system.

Determining Market Rent

In some embodiments, the first property information includes rent data for a plurality of tenants including the first tenant, and determining the market rent includes determining the market rent based on the rent data for the plurality of tenants. In some embodiments, the first property information includes rent data for a plurality of tenants including the first tenant, and determining the market rent includes determining the market rent based on a highest rent of the rent data for the plurality of tenants. In some embodiments, the first property information includes rent data for a plurality of tenants including the first tenant, and determining the market rent includes determining the market rent based on an average rent of the rent data for the plurality of tenants. In some embodiments, the first property information includes rent data for a plurality of tenants including the first tenant, and determining the market rent includes determining the market rent based a statistical analysis of the rent data for the plurality of tenants.

In some embodiments, the property management platform system includes rent data for a plurality of properties including a first property of the first property address, and determining the market rent includes determining the market rent for a tenant of the first property based on the rent data for the plurality of properties. In some embodiments, the property management platform system includes rent data for a plurality of properties including a first property of the first property address, and determining the market rent includes determining the market rent for a tenant of the first property based on a highest rent of the rent data for the plurality of properties. In some embodiments, the property management platform system includes rent data for a plurality of properties including a first property of the first property address, and determining the market rent includes determining the market rent for a tenant of the first property based on an average rent of the rent data for the plurality of properties. In some embodiments, the property management platform system includes rent data for a plurality of properties including a first property of the first property address, and determining the market rent includes determining the market rent for a tenant of the first property based on a statistical analysis of the rent data for the plurality of properties.

In some embodiments, the property management platform system includes rent data for a plurality of properties of a first location of the first property address, and determining the market rent includes determining the market rent for a tenant of the first property based on the rent data for the plurality of properties of the first location. In some embodiments, the property management platform system includes rent data for a plurality of properties of a first location of the first property address, and determining the market rent includes determining the market rent for a tenant of the first property based on a highest rent of the rent data for the plurality of properties of the first location. In some embodiments, the property management platform system includes rent data for a plurality of properties of a first location of the first property address, and determining the market rent includes determining the market rent for a tenant of the first property based on an average rent of the rent data for the plurality of properties of the first location. In some embodiments, the property management platform system includes rent data for a plurality of properties of a first location of the first property address, and determining the market rent includes determining the market rent for a tenant of the first property based on a statistical analysis of the rent data for the plurality of properties of the first location.

In some embodiments, monitoring includes: determining a market rent for the first property based on listing information accessed from a listing database system for a location of the first property address; determining to generate a market rent notification responsive to a determination that the market rent exceeds the first tenant rent data by a threshold value, wherein generating the notification includes: generating a market rent notification. In some embodiments, monitoring includes: determining a market rent for the first property based rent data stored by the property management platform system; determining to generate a market rent notification responsive to a determination that the market rent exceeds the first tenant rent data by a threshold value, wherein generating the notification includes: generating a market rent notification.

### Notification Response Process

In some embodiments, a notification response process includes at least one of generating loan application information, generating a tenant letter, generating a property reassessment request, and generating a tax refund request. In some embodiments, the notification response process is performed by an external system. In some embodiments, the notification response process is performed by the property management platform system 110.

### Notification Response Process Using a Service Provider System

In some embodiments, performing a notification response process responsive to generation of the notification (process S209) includes: providing the notification to a second service provider system. In some embodiments, performing a notification response process responsive to generation of the notification (process S209) includes: providing the notification to a second service provider system, wherein the second service provider system performs a third-party notification response process.

### Notification Response Process Using a Vendor System

In some embodiments, performing a notification response process responsive to generation of the notification (process S209) includes: providing the notification to a vendor system. In some embodiments, performing a notification response process responsive to generation of the notification (process S209) includes: providing the notification to a vendor system, wherein the vendor system performs a third-party notification response process.

### Notification Response Process: Generate Loan Application Information

In some embodiments, the notification is a notification to suggest a new loan, and performing a notification response process responsive to generation of the notification (process S209) includes: generating loan application information by using the first property information and information of the notification.

### Notification Response Process: Generate Tenant Letter

In some embodiments, the notification is a lease violation notification, and performing a notification response process responsive to generation of the notification (process S209) includes: generating a tenant letter by using the information of the notification.

### Notification Response Process: Property Tax Notification Response

In some embodiments, the notification is a property tax notification, and performing a notification response process responsive to generation of the notification (process S209) includes: generating a reassessment request by using the information of the notification. In some embodiments, the notification is a property tax notification, and performing a notification response process responsive to generation of the notification (process S209) includes: generating a tax refund request by using the information of the notification.

### Management of Property Information

In some embodiments, one or more properties are associated with a property group (portfolio), and information for the property groups is stored in association with user account information for one or more users. In some embodiments, a property is shared among two or more property groups, an ownership percentage of the shared property for a first property group is stored in association with information for the first property group, and an ownership percentage of the shared property for a second property group is stored in association with information for the second property group. In some embodiments, a property group is shared among two or more users, an ownership percentage of the shared property group for the first user is stored in association with user account information for the first user, and an ownership percentage of the shared property group for the second user is stored in association with user account information for the second first user. In some embodiments, information of a property group includes information of another property group. In some embodiments, information of two or more property groups are stored in association user account information of a user. In some embodiments, a property view is generated for each user. In some embodiments, a property view for a user includes information for each property group that is stored in association with user account information of the user. In some embodiments, a property view for a user includes information for each property group that is stored in association with user account information of the user, and the platform system adjusts the property group information based on at least one ownership percentage for the user. In some embodiments, a property view for a user includes information for each property group that is stored in association with user account information of the user, and the platform system adjusts the property group information based on at least one property group ownership percentage for the user. In some embodiments, a property view for a user includes information for each property group that is stored in association with user account information of the user, and the platform system adjusts the property group information based on at least one property ownership percentage for a property included in a property group associated with the user.

In some embodiments, sharable property group information is generated for a property group of a user. In some embodiments, sharable property group information is generated for a property group of a user by redacting at least a portion of the property group information for the property group. In some embodiments, sharable property group information is generated for a property group of a user by obfuscating at least a portion of the property group information for the property group. In some embodiments, a plurality of properties is associated with a first user. In some embodiments, the user registers at least two properties of a property group associated with the first user. In some embodiments, the first user registers at least two properties of a property group associated with the first user. In some embodiments, the first user registers a first property of a property group associated with the first user, and a second user registers a second property of the property group associated with the first user.

### Property Metrics

In some embodiments, the platform system 110 provides the first user device (e.g., 121) with property metrics generated by the platform system based on information stored by the platform system in association with the first property address, and based on the monitored additional information. In some embodiments, the property metrics include at least one of at least one of rent roll information, operating expense information, and loan-to-value information. In some embodiments, the platform system 110 provides the property metrics via at least one of a dashboard, a notification, and an alert.

In some embodiments, the platform system 110 generates at least one of a P&L statement (profit and loss statement), a rent-roll, and schedule of real-estate (e.g., schedule of real estate for properties owned by a user of the first user account) for the first user account based on information stored by the platform system in association with the first property address, and based on the monitored additional information.

### User-Provided Transaction Information

In some embodiments, a user might choose to manually upload account service provider data such as a utility bill or bank statement instead of connecting an account. In some embodiments, a method includes: at a property management platform system: receiving (from one of an external first user device and an external first user system) first user account information for a first user account of the platform system, a first property address, and first transaction information for a service provider account of an external first service provider system; storing first property information in association with the first user account information and the first transaction information, wherein the first property information includes the first property address; monitoring additional information for the first property address to determine whether to generate a notification for the first property address; and responsive to a determination to generate the notification, generating the notification; wherein monitoring additional information includes: accessing first property data for the first property address from an external property database system; and accessing listing information from a listing database for a location of the first property address.

In some embodiments, the user system provides the information to the platform system via an API (Application Program Interface) of the platform system.

In some embodiments, the user system communicatively coupled to a user device (e.g., 121, 122), and the user system provides the first user account information, the first property address, and the first transaction information to the platform system via the API responsive to a provisioning request received by the user system from the user device.

In some embodiments, the API is a REST API.

In some embodiments the method includes receiving first tenant rent data for the first property address and storing the first property information in association with the first tenant rent data.

### Automatic Account Selection

In some embodiments, accounts are automatically matched to properties based on service provider data rather than having the user select the account. In some embodiments, a method includes at a property management platform system: receiving, (from one of an external first user device and a first user system), first user account information for a first user account of the platform system, a first property address, and first access information for an external first service provider system; accessing a list of accounts from the first service provider system by using the first access information; automatically selecting a first service provider account of the list of accounts based on service provider data of the first service provider system; storing first property information in association with the first user account information, an identifier of the first service provider account, and the first access information, wherein the first property information includes the first property address; monitoring additional information for the first property address to determine whether to generate a notification for the first property address; and responsive to a determination to generate the notification, generating the notification, wherein monitoring additional information includes: accessing first transaction information for the first service provider account from the first service provider system by using the first access information; accessing first property data for the first property address from an external property database system; and accessing listing information from a listing database for a location of the first property address.

In some embodiments, the user system provides the information to the platform system via an API (Application Program Interface) of the platform system.

In some embodiments, the user system is communicatively coupled to a user device (e.g., 121, 122), and the user system provides the first user account information, the first property address, and the first access information to the platform system via the API responsive to a provisioning request received by the user system from the user device.

In some embodiments, the API is a REST API.

In some embodiments the method includes receiving first tenant rent data for the first property address and storing the first property information in association with the first tenant rent data.

### Intermediary Data Provider

In some embodiments, a method includes at a property management platform system: receiving (from one of an external first user device and an external first user system), first user account information for a first user account of the platform system, a first property address, and first access information for an external first intermediary data provider system; accessing a list of accounts from the first intermediary data provider system by using the first access information; receiving, from the first user device, first intermediary data provider account user selection of a first provider account of the list of accounts; storing first property information in association with the first user account information, an identifier of the first provider account, and the first access information, wherein the first property information includes the first property address; monitoring additional information for the first property address to determine whether to generate a notification for the first property address; and responsive to a determination to generate the notification, generating the notification, wherein monitoring additional information comprises: accessing first transaction information for the first provider account from the first intermediary data provider system by using the first access information; accessing first property data for the first property address from an external property database system; and accessing listing information from a listing database for a location of the first property address.

In some embodiments, the first intermediary data provider system is an accounting system.

In some embodiments, the user system provides the information to the platform system via an API (Application Program Interface) of the platform system.

In some embodiments, the user system is communicatively coupled to a user device (e.g., 121, 122), and the user system provides the first user account information, the first property address, and the first access information to the platform system via the API responsive to a provisioning request received by the user system from the user device.

In some embodiments, the user system is communicatively coupled to a user device (e.g., 121, 122), and the user system provides the first user account information, the first property address, the first access information, and the first intermediary data provider account user selection to the platform system via the API responsive to a provisioning request received by the user system from the user device.

In some embodiments, the API is a REST API.

In some embodiments the method includes receiving first tenant rent data for the first property address and storing the first property information in association with the first tenant rent data.

### Additional Embodiments

In some embodiments, a method includes at a property management platform system: receiving (from one of an external first user device and an external first user system), first user account information for a first user account of the platform system, a first property address, and first access information for an external first service provider system; accessing a list of accounts from the first service provider system by using the first access information; receiving, from the first user device, first service provider account user selection of a first service provider account of the list of accounts; storing first property information in association with the first user account information, an identifier of the first service provider account, and the first access information, wherein the first property information includes the first property address; monitoring additional information for the first property address to determine whether to generate a notification for the first property address; and responsive to a determination to generate the notification, generating the notification, wherein monitoring additional information comprises: accessing first transaction information for the first service provider account from the first service provider system by using the first access information; accessing first property data for the first property address from an external property database system; and accessing listing information from a listing database for a location of the first property address.

In some embodiments, the user system provides the information to the platform system via an API (Application Program Interface) of the platform system.

In some embodiments, the user system is communicatively coupled to a user device (e.g., 121, 122), and the user system provides the first user account information, the first property address, and the first access information to the platform system via the API responsive to a provisioning request received by the user system from the user device.

In some embodiments, the user system is communicatively coupled to a user device (e.g., 121, 122), and the user system provides the first user account information, the first property address, the first access information, and the first service provider account user selection to the platform system via the API responsive to a provisioning request received by the user system from the user device.

In some embodiments, the API is a REST API.

In some embodiments the method includes receiving first tenant rent data for the first property address and storing the first property information in association with the first tenant rent data.

### System Architecture

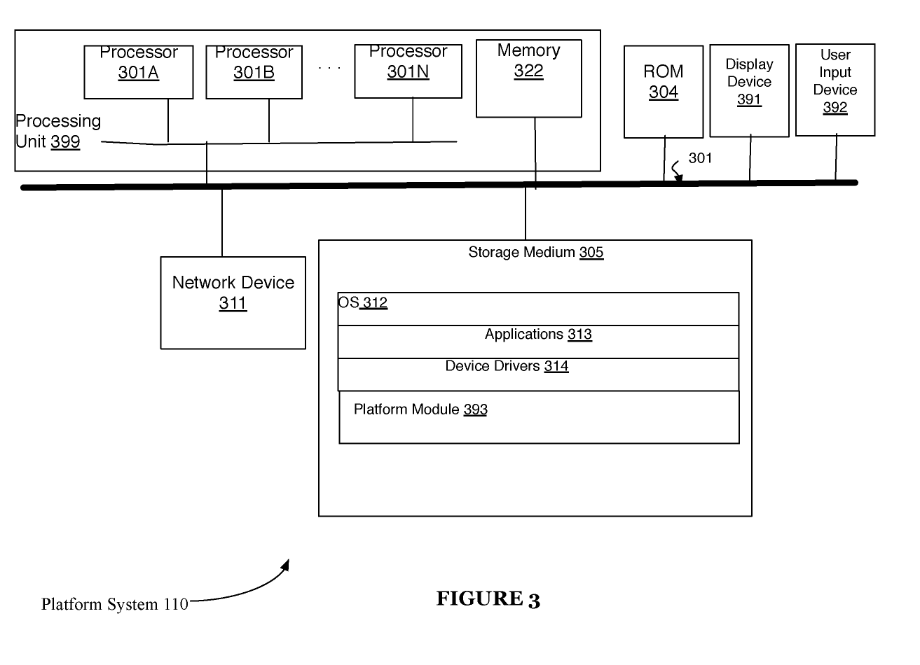

FIG. 3 is a diagram depicting system architecture of a property management platform system, according to embodiments. FIG. 3 is an architecture diagram of a system (e.g., 110 of FIG. 1) according to an embodiment in which the platform system is implemented by a server device. In some embodiments, the platform system is implemented by a plurality of devices.

In some embodiments, the platform system is implemented by a server device that includes machine-executable instructions (and related data) for a property management platform module 393.

In some embodiments, the platform system is implemented by a plurality of devices, and the plurality of devices include machine-executable instructions (and related data) for the property management platform module 393.

The bus 301 interfaces with the processors 301A-301N, the main memory (e.g., a random access memory (RAM)) 322, a read only memory (ROM) 304, a processor-readable storage medium 305, and a network device 311. In some embodiments, the platform system includes at least one of a display device 391 and a user input device 392.

The processors 301A-301N may take many forms, such as ARM processors, X86 processors, and the like.

In some embodiments, the platform system includes at least one of a central processing unit (processor) and a multi-processor unit (MPU).

The processors 301A-301N and the main memory 322 form a processing unit 399. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes the property management platform module 393.

The network device 311 provides one or more wired or wireless interfaces for exchanging data and commands between the platform system and other devices, such as a user device (e.g., 121, 122) and an external system (e.g., one of 130-170 of FIG. 1). Such wired and wireless interfaces include, for example, a universal serial bus (USB) interface, Bluetooth interface, an optical interface, Wi-Fi interface, Ethernet interface, near field communication (NFC) interface, and the like.

Machine-executable instructions in software programs (such as an operating system, application programs, and device drivers) are loaded into the memory 322 (of the processing unit 399) from the processor-readable storage medium 305, the ROM 304 or any other storage location. During execution of these software programs, the respective machine-executable instructions are accessed by at least one of processors 301A-301N (of the processing unit 399) via the bus 301, and then executed by at least one of processors 301A-301N. Data used by the software programs are also stored in the memory 322, and such data is accessed by at least one of processors 301A-301N during execution of the machine-executable instructions of the software programs. The processor-readable storage medium 305 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. In some embodiments, the processor-readable storage medium 305 includes machine-executable instructions (and related data) for an operating system 312, software programs 313, device drivers 314, and the property management platform module 393. The property management platform module 393 includes machine-executable instructions for performing the methods described herein.

### Machines

The systems and methods of some embodiments and variations thereof can be embodied and/or implemented at least in part as a machine configured to receive a computer-readable medium storing computer-readable instructions. The instructions are preferably executed by computer-executable components. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### Conclusion

As a person skilled in the art will recognize from the previous detailed description and from the figures and claims, modifications and changes can be made to the embodiments disclosed herein without departing from the scope defined in the claims.

1. A method comprising: at a property management platform system:
receiving, from an external first user device, first user account information for a first user account of the platform system, a first property address, and first access information for an external first service provider system;
accessing a list of accounts from the first service provider system by using the first access information;
receiving, from the first user device, first service provider account user selection of a first service provider account of the list of accounts;
receiving first tenant rent data for the first property address;
storing first property information in association with the first user account information, an identifier of the first service provider account, the first access information, and the first tenant rent data, wherein the first property information includes the first property address;
monitoring additional information for the first property address to determine whether to generate a notification for the first property address; and
responsive to a determination to generate the notification, generating the notification,
wherein monitoring additional information comprises:
accessing first transaction information for the first service provider account from the first service provider system by using the first access information;
accessing first property data for the first property address from an external property database system; and
accessing listing information from a listing database for a location of the first property address.

2. The method of claim 1, wherein the additional information includes the first transaction information, the first property data, and the listing information.

3. The method of claim 2, further comprising: the property management platform system providing the notification to at least one of the first user device and a second user device.

4. The method of claim 2, further comprising: the property management system performing a notification response process in response to generation of the notification.

5. The method of claim 1, wherein the notification includes one of a new vendor notification, a new loan notification, a tenant notification, a public service notification, a crowdsourced suggestion notification, a lease violation notification, a utility notification, a property tax notification, and a market rent notification.

6. The method of claim 5, wherein monitoring comprises:
accessing current loan information of a current loan for the first property address; and
determining to generate the notification in a case where a current interest rate indicated by the current loan information exceeds a loan interest rate threshold value,
wherein generating the notification comprises: generating a new loan notification.

7. The method of claim 5, wherein monitoring comprises:
accessing current loan information of a current loan for the first property address; and
determining to generate the notification based on an expiration date of a fixed rate term of a variable loan as indicated by the current loan information,
wherein generating the notification comprises: generating a new loan notification.

8. The method of claim 5, wherein monitoring comprises:
accessing current loan information of a current loan for the first property address;
accessing new loan information provided by a plurality of external loan service provider systems; and
determining to generate the notification in a case where a current interest rate indicated by the current loan information exceeds at least one interest rate specified by the new loan information,
wherein generating the notification comprises: generating a new loan notification.

9. The method of claim 5, wherein monitoring comprises:
accessing current loan information of a current loan for the first property address;
determining whether a second property address is stored by the platform system in association with the first user account information;
in a case where the second property address is stored by the platform system in association with the first user account information, accessing new portfolio loan information provided by a plurality of external loan service provider systems; and
determining to generate the notification in a case where a current interest rate indicated by the current loan information exceeds at least one interest rate specified by the new portfolio loan information,
wherein the accessed portfolio loan information includes interest rate information for a loan for both the first property address and the second property address, and
wherein generating the notification comprises: generating a new portfolio loan notification.

10. The method of claim 5, wherein monitoring comprises:
determining a charge for vendor services provided for the first property address by a current vendor based on the first transaction information;
accessing vendor information for at least one new vendor from an external system; and
determining to generate the new vendor notification in a case where a charge for the current vendor is greater than pricing information for at least one new vendor of the accessed vendor information,
wherein generating the notification comprises: generating a new vendor notification.

11. The method of claim 5, wherein monitoring comprises:
determining a rating for a current vendor that provides a service for the first property address;
determining a rating for at least one new vendor by using an external system; and
determining to generate the new vendor notification in a case where a rating for the current vendor is lower than the determined rating for the at least one new vendor,
wherein generating the notification comprises: generating a new vendor notification.

12. The method of claim 5, wherein monitoring comprises:
determining a current residence location for a tenant of the first property address by using an external social media system; and
determining to generate a tenant notification in a case where the current residence location is different from a location of the first property address,
wherein generating the notification comprises: generating a tenant notification.

13. The method of claim 5, wherein monitoring comprises:
determining a current residence location for a tenant of the first property address by using an external credit bureau system; and
determining to generate a tenant notification in a case where the current residence location is different from a location of the first property address,
wherein generating the notification comprises: generating a tenant notification.

14. The method of claim 5, wherein monitoring comprises:
accessing vacation rental listing information from an external vacation rental system; and
determining to generate a lease violation notification in a case where the first property address is identified by the accessed vacation rental listing information,
wherein generating the notification comprises: generating a lease violation notification.

15. The method of claim 5, wherein monitoring comprises:
identifying a current utility cost for a first utility by using the first transaction information;
identifying a previous utility cost for the first utility by using the first transaction information, and
determining to generate a utility notification responsive to a determination that a difference between the current utility cost and the previous utility cost corresponds to an increase in a utility cost for the first utility above a threshold value for the first utility,
wherein generating the notification comprises: generating a utility notification.

16. The method of claim 5, wherein monitoring comprises:
determining an assessed value for the first property address by accessing an assessor database system;
determining a current property value for the first property address; and
determining to generate a property tax notification responsive to a determination that the assessed value for the first property address is greater than the current property value for the first property address by a threshold value,
wherein generating the notification comprises: generating a property tax notification.

17. The method of claim 16, wherein the platform system determines the current property value based on tenant rent information stored in association with the first property address.

18. The method of claim 16, wherein the platform system determines the current property value based on information accessed from an external property database system.

19. The method of claim 5, wherein monitoring comprises:
determining a market rent for the first property address based on listing information accessed from a listing database system for a location of the first property address; and
determining to generate a market rent notification responsive to a determination that the market rent exceeds the first tenant rent data by a threshold value,
wherein generating the notification comprises: generating a market rent notification.

20. The method of claim 5, wherein monitoring comprises:
determining a market rent for the first property address based rent data stored by the property management platform system; and
determining to generate a market rent notification responsive to a determination that the market rent exceeds the first tenant rent data by a threshold value,
wherein generating the notification comprises: generating a market rent notification.
